(19) United States
(12) Patent Application Publication
(10) Pub. No.: US 2012/0043832 A1
(43) Pub. Date: Feb. 23, 2012

(54) COMPACT LINEAR ACTUATOR WITH ROTARY MECHANISM

(76) Inventors: Edward A. NEFF, Cardiff By the Sea, CA (US); Toan M. Vu, San Diego, CA (US)

(21) Appl. No.: 12/860,809

(22) Filed: Aug. 20, 2010

(51) Int. Cl. H02K 41/02

(52) U.S. Cl. 310/12.14

(57) ABSTRACT

Methods and apparatus for a compact linear actuator having an improved rotary mechanism are disclosed herein. In one embodiment, the linear actuator comprises a spline bearing for guiding the shaft of the actuator as it is linearly actuated. A rotor positioned around the spline bearing rotatably engages the spline bearing when magnetically actuated by a surrounding stator. A rotational lock connected to the piston assembly may be used to prevent the piston assembly from rotating during operation. Optionally, a rotary scale may be attached to the spline bearing in order to indicate how far the shaft has rotated. Since the shaft does not bear the mass of the rotary mechanism, linear performance of the actuator is substantially improved.

### FIELD OF THE INVENTION

The present invention relates generally to the field of linear actuators. More particularly, the present invention is directed in one exemplary aspect to compact linear actuators having a rotary mechanism.

### BACKGROUND OF THE INVENTION

Linear actuators are mechanical devices which are used to perform repetitive actions requiring linear motion. For example, linear actuators can be used in an assembly plant for placing caps on bottles, for automatically stamping or labeling mail, for glass cutting, for placing chips on circuits, for testing various buttons or touch areas on electronic devices, for automation, and for a wide variety of other purposes as well.

In certain applications, both linear and rotational motion are necessary to complete a designated task (for example, tightening screws and other such fasteners, laser welding, surface scanning or surface treatment application, light deflection using rotatable mirrors, etc.). In order to accomplish such rotation, a rotary motor can be affixed to the piston assembly of the actuator. However, this causes the linear motion of the actuator to become significantly slower since now the actuator must bear the mass of the rotary motor.

Therefore, a need exists for a linear actuator which can perform tasks requiring rotation, but without suffering an attendant loss in linear operational speed, force, and/or acceleration. Such an actuator should be compact, flexible, and yet still possess the ability to monitor and/or control the task being performed.

### SUMMARY OF THE INVENTION

Various embodiments of the present invention are therefore directed to a linear rotary actuator which satisfies each of the foregoing needs. More specifically, various embodiments of the present invention are directed to a linear rotary actuator with increased operational performance, the ability to transmit positional feedback (i.e., both linear and rotational data) to a remote device, as well as the ability to receive positional data specifying the amount of linear and rotational movement necessary for performing a particular task.

In a first aspect of the invention, a linear rotary actuator is disclosed. In one embodiment, the linear rotary actuator includes: a piston assembly comprising a rotatable shaft and a lock for engaging a pin adapted to prevent the piston assembly from rotating, wherein the shaft includes a groove for interfacing with a first bearing; the first bearing adapted to engage the shaft at the groove and therefore prevent the shaft from rotating relative to the first bearing; a second bearing comprising a magnet and adapted for being positioned around the first bearing; and a stator comprising a set of coils and adapted for being positioned around the second bearing, wherein the second bearing is adapted to rotatably engage the first bearing when current is flowing through the set of coils.

In a second aspect of the invention, a method is disclosed for rotatably engaging a first shaft disposed within the piston assembly of a linear actuator with a rotary motor that remains fixed irrespective of the linear position of the first shaft. In one embodiment, the method includes: positioning a stator comprising a set of coils around a rotary bearing comprising at least one magnet; positioning the rotary bearing around a first spline bearing adapted to receive the first shaft, wherein the rotary bearing is adapted to rotatably engage the first spline bearing, and wherein the first spline bearing is adapted to prevent rotation of the first shaft relative to the first spline bearing; inserting a second shaft into a rotational lock formed within the piston assembly; inserting the first shaft into the first spline bearing; and running an electrical current through the set of coils.

In a third aspect of the invention, an apparatus for performing a task requiring linear and rotational motion is disclosed. In one embodiment, the apparatus includes: a piston assembly comprising a lock adapted to prevent the piston assembly from rotating; a spline shaft connected to the piston assembly; a rotary motor comprising a stator and a rotor, wherein the rotor comprises at least one magnet, and wherein the stator comprises a set of coils and is positioned around the rotor; and a spline bearing positioned inside the rotor and adapted to interface with the spline shaft at a groove formed within the spline shaft.

These and other embodiments are described in more detail with reference to the following description and accompanying figures. Note that the following description and accompanying figures are merely exemplary in nature and should not be used to construe the invention as being limited to the specific embodiments described and illustrated herein.

### BRIEF DESCRIPTION OF THE DRAWINGS

FIG. 1 is a first exploded view of an exemplary linear actuator having a rotary motor according to one embodiment of the present invention.

FIG. 2 is a second exploded view of the exemplary linear actuator as depicted in FIG. 1.

FIG. 3A is a first cut-away view of an exemplary linear actuator having a rotary motor according to one embodiment of the present invention.

FIG. 3B is a second cut-away view of the exemplary linear actuator as depicted in FIG. 3A.

FIG. 3C is a third cut-away view of the exemplary linear actuator as depicted in FIG. 3A.

FIG. 3D is a fourth cut-away view of the exemplary linear actuator as depicted in FIG. 3A.

FIG. 4 is a flow diagram of an exemplary method of rotatably engaging a shaft with a rotary motor that remains fixed irrespective of the linear position of the shaft according to one embodiment of the present invention.

### DETAILED DESCRIPTION OF THE EXEMPLARY EMBODIMENTS

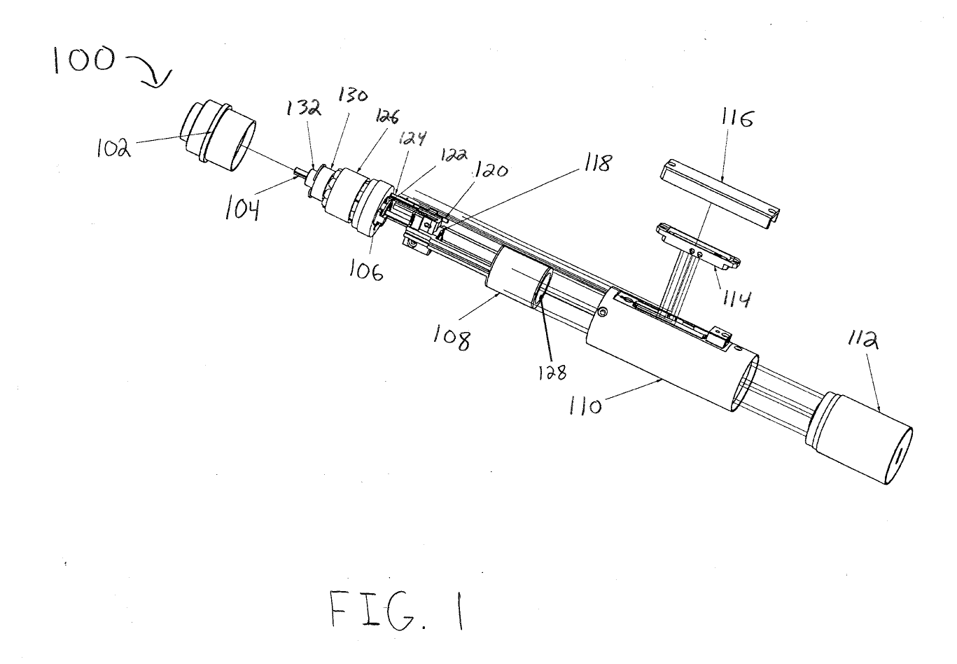

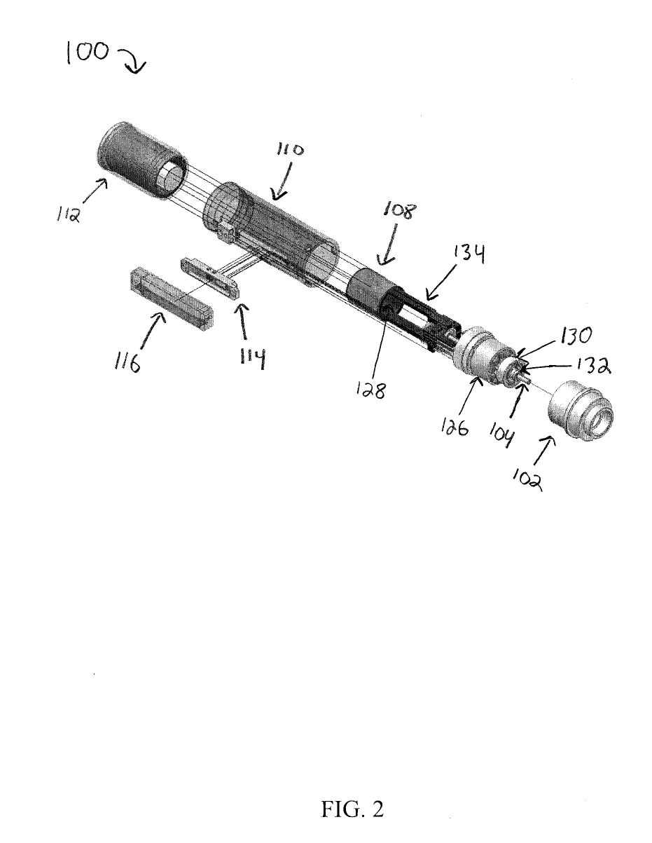

FIG. 1 and FIG. 2 are exploded views of an exemplary linear actuator 100 having a rotary motor according to embodiments of the present invention. As shown by these figures, the linear actuator 100 includes a rotary motor housing 102, a spline shaft 104, a rotary encoder 106, a coil 108, a main housing 110, a magnet housing 112, a linear encoder 114, an encoder housing 116, a rotary bearing 118, a rotational lock 120, a rotary scale 122, a linear scale 124, a stator 126, a bobbin 128, a rotor 130, a spline bearing 132, and a piston assembly 134.

In some embodiments, all or a portion of the manufactured parts can be machined on a CNC lathe such as the Hardinge model RS51MSY or other lathe that has the ability to machine both ends of a component (e.g., via sub-spindle transfer) as well as the ability to do mill work. According to some embodiments, each part can be made in a single operation on the lathe, thereby reducing and/or eliminating the need for secondary operations. These secondary operations present additional costs and may also reduce quality by increasing dimensional variation.

In some embodiments, various components of the linear actuator 100 may be manufactured from aluminum or steel bars. Note, however, that a myriad of other materials may be used according to embodiments of the present invention.

As best shown in FIG. 2, the piston assembly 134 may include at least one bobbin 128 for supporting an electrically conductive medium such as coil 108. During operation, current is introduced through the coil 108 thereby creating a magnetic field having a direction that depends upon the direction that the current is flowing through the coil 108.

In some embodiments, the piston assembly 134 and the bobbin 128 may be formed as a single, unitary piece. A single, unitary piece can make construction of the actuator 100 less complicated and quicker to assemble because there are fewer pieces. Moreover, using a single, unitary piece can be more cost effective, as a single piece can be less costly to produce than multiple separate pieces. A single, unitary piece can also weigh less than a multi-piece piston-bobbin assembly since such an assembly may require additional fasteners or hardware to attach the various components together.

The magnet housing 112 may include one or more magnets (for example, substantially cylindrical magnets or circular magnet segments) which may be easily fastened inside the magnet housing 112 during manufacturing with various adhesives or screws. Such magnets are adapted to magnetically interface with the piston assembly 134 when a magnetic field is present. Hence, by repeatedly alternating the direction that current is flowing through the coil 108, a linear force may be repeatedly imparted upon the piston assembly 108.

Note that while FIG. 1 and FIG. 2 each depict a single-coil actuator 100, in other embodiments, the piston assembly 134 may include multiple coils 108 supported by separate bobbins 128 of the same piston assembly 134, as well as a magnet housing 112 containing a series of alternately magnetized magnets (e.g., NS, SN, NS, etc.). Persons skilled in the art will recognize that the magnet housing 112 and piston assembly 134 for such a multi-pole configuration can be implemented using standard machining processes.

In some embodiments, stroke variation and encoder resolution may be easily adjusted, thereby reducing costs associated with reconfiguring and/or replacing the actuator. Where stroke is a function of three assemblies (the magnet housing 112, the piston assembly 134, and the main housing 110) a replaceable magnet housing 112 may be used to increase the length of the stroke, yet without requiring replacement of more expensive components that are serviceable in all stroke variations (e.g., the piston assembly 134 and the main housing 110). For example, the magnet housing 112 may be replaced with a more elongated magnet housing 112, thereby enabling a longer actuator stroke.

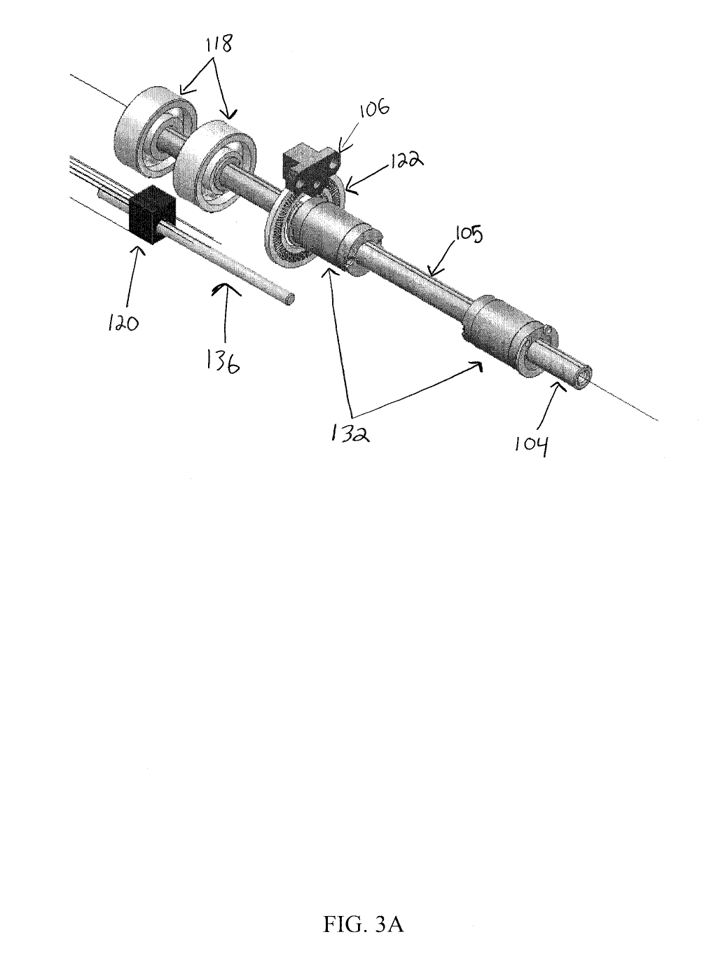

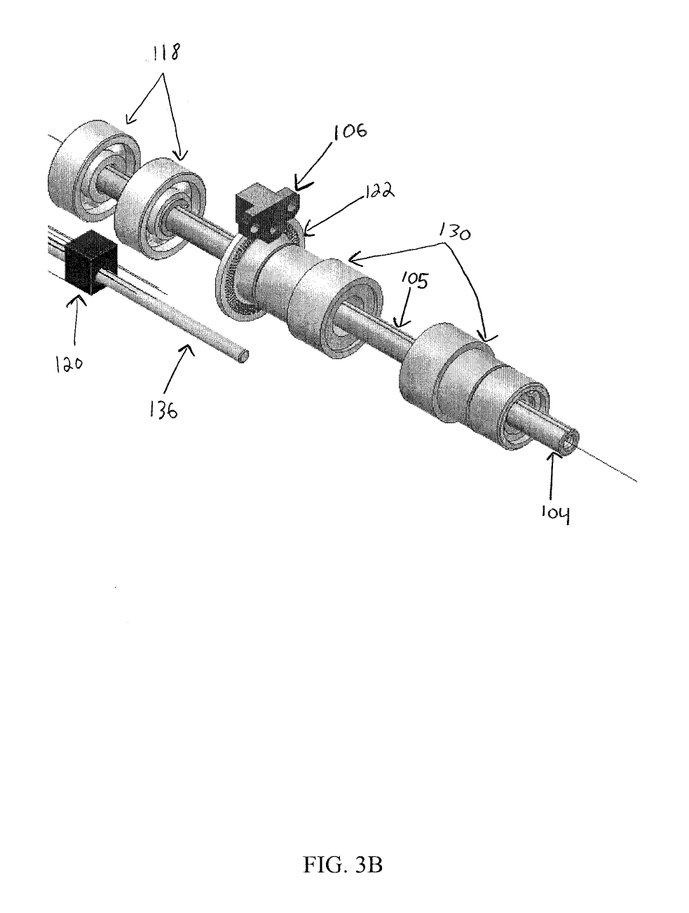

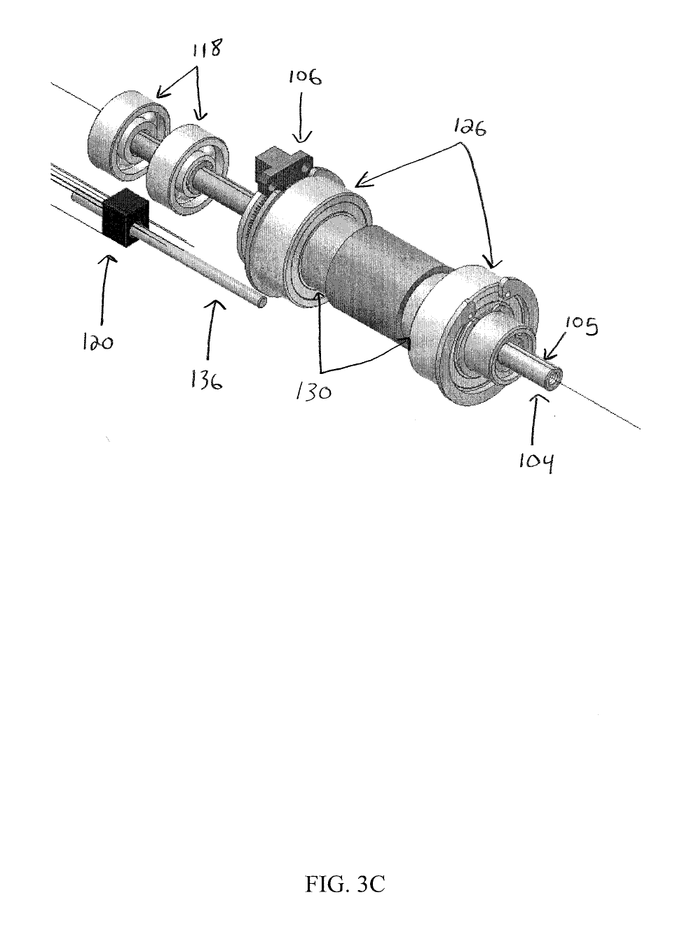

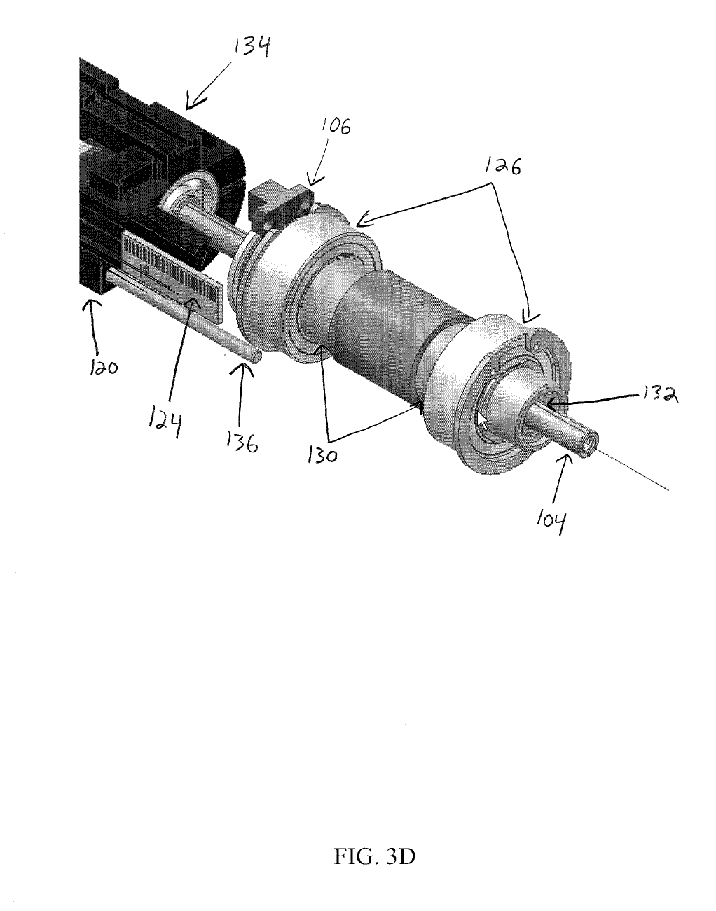

As best shown in FIG. 2, the side of the piston assembly 134 opposite the coil 108 includes an interface for securing a spline shaft 104. Such a spline shaft 104 may include, for example, a metallic shaft having one or more slits or grooves 105 (see, e.g., FIG. 3C) running along its length.

One or more spline bearings 132 (e.g., annular bearings) having protrusions corresponding to the grooves 105 of the spline shaft 104 are adapted to receive the spline shaft and thereby prevent the shaft 104 from rotating relative to the spline bearings 132. The spline bearings 132 may also serve to reduce the level of friction associated with linear movement of the shaft 104 relative to the spline bearings 132. In order to accomplish this, the spline bearings 132 may include a set of balls, globules, or other such spherical bodies for circulating around a track within each respective bearing 132 as the shaft 104 is driven through each bearing 132. In this manner, the spline bearings 132 may serve as a linear guide to the spline shaft 104 so as to prevent unwanted rotation of the shaft 104 and to further enable linear movement of the shaft 104 with a reduced amount of associated friction. In one embodiment, the spline bearing 132 may include a linear guide assembly manufactured by IKO Inc. (#MAG8CITHS2/N). Note, however, that a myriad of other structures/guide assemblies may be utilized according to the scope of the present invention.

In some embodiments, the central axis of the bobbin 128 supporting coil 108 is approximately collinear with the spline shaft 104. This design can help reduce or eliminate an unwanted moment, or a lateral force which may otherwise translate to the piston assembly 134 if the coil were positioned to one side of the piston assembly 134. Such a design can improve force repeatability which is particularly useful in precise force applications such as small electronic parts assembly and precision glass scoring.

In some embodiments, the piston assembly 134 may include a linear scale 124 for indicating linear positional feedback to a linear encoder 114. As shown in FIG. 1 and FIG. 2, the linear encoder 114 may be situated within an encoder housing 116 which is itself disposed within a cutout of the main housing 110. The encoder housing 116 can be fastened to the main housing 110 of the actuator 100 using screws, for example. The linear encoder 114 may thus remain fixed within the main housing 110 as the piston assembly 134 is repeatedly actuated.

As best shown by FIG. 3D, the linear scale 124 may include a series of stripes or markings running along the length of the scale. When the piston assembly 134 is actuated, the linear encoder 114 (e.g., an optical reader) may count the number of stripes or markings read in order to determine the current linear position of the piston assembly 134. In some embodiments, recorded positional data may then be transmitted to a remote device for monitoring purposes. In some embodiments, a user can input one or more values to a remote device (such as a connected computer) in order to designate an amount of linear movement desired for a particular task. These values can then be transmitted to a controller (not shown) in electrical communication with the linear encoder 114 so that linear movement of the piston assembly can be adjusted according to the values specified.

In order to enable the linear actuator 100 to perform tasks requiring rotation, a rotational lock 120, a rotary bearing 118, and a rotary motor including stator 126 and rotor 130 may be utilized in conjunction with the various components mentioned above for enabling linear operation. These components are best described and illustrated with reference to the following figures.

FIGS. 3A-3D are various cut-away views of an exemplary linear actuator having a rotary motor according to one embodiment of the present invention. According to the design of the embodiments depicted in these figures, the rotary motor remains fixed irrespective of the linear position of the shaft 104, thereby enabling the shaft 104 to move in linear direction without being substantially encumbered by the mass of the rotary motor. A smaller force is thereby necessary to drive the linear actuator 100 at a designated acceleration. Similarly, a greater acceleration is attainable for a specified amount of force.

Referring first to FIG. 3A, the first cut-away view depicts a spline shaft 104 with one or more grooves 105 running along its length, one or more spline bearings 132 for guiding the spline shaft 104 upon being actuated in a linear direction, a rotary scale 122 for indicating rotational feedback to a rotary encoder 106, one or more rotary bearings 118 for enabling rotation of the shaft 104 relative to the piston assembly 134 (not shown), and a rotational lock 120 for preventing the piston assembly from rotating as the shaft 104 is rotated.

As discussed above with reference to FIGS. 1 and 2, the one or more spline bearings 132 are adapted to prevent the shaft 104 from rotating relative to the spline bearings 132. Thus, when the spline bearings 132 remain fixed, movement of the shaft 104 is linearly guided by the spline bearings 132 along the grooves 104 of the spline shaft 104, thereby preventing rotation.

However, even though the spline shaft 104 may not rotate relative to the spline bearings 132, the spline shaft 104 and spline bearings 132 may rotate in tandem relative to the piston assembly 134 (not shown). One or more rotary bearings 118 positioned at the proximal end of the spline shaft 104 may be used to secure the shaft 104 to the piston assembly 134, yet also enable the shaft 104 and spline bearings 132 to rotate relative to the piston assembly 134.

The piston assembly 134 may include a rotational lock 120 for preventing the piston assembly 134 from rotating during operation. The rotational lock 120 may include one or more apertures for receiving a locking pin 136, spline shaft, or other such locking mechanism while remains fixed while the shaft 104 is rotated. In some embodiments, the rotational lock 120 may be formed directly within the piston assembly 134, thereby reducing the number of parts necessary for assembly of the linear actuator 100. In some embodiments, the rotational lock 120 may include a spline bearing 132 for reducing the amount of friction between the rotational lock 120 and the locking pin 136 as the piston assembly 134 is actuated and the rotational lock 120 slides upon the spline shaft or locking pin 136.

Optionally, the linear actuator 100 may include a rotary scale 122 for indicating rotational feedback to a rotary encoder 106. As best shown in FIG. 3A and FIG. 3B, the rotary scale 122 may include a series of stripes or markings oriented radially across the surface of the rotary scale 122. When the spline bearings 132 are rotated, the rotary encoder 106 (e.g., an optical reader) may count the number of stripes or markings it has read in order to determine how far the spline shaft 104 has rotated. Rotational data recorded in this manner may then be transmitted to a remote device for monitoring purposes.

According to some embodiments, a user can input one or more parameters to a remote device (such as a connected computer) in order to designate an amount of rotational movement desired for a particular task. These values can then be transmitted to a controller (not shown) in electrical communication with the rotary encoder 106 so that rotational movement of the spline shaft 104 can be adjusted according to the values specified.

Referring next to FIG. 3B, the shaft 104 of the actuator 100 is presented with one or more rotors 130 for rotatably engaging the spline bearings 134. In some embodiments, the one or more rotors 130 include rotary bearings each containing at least one magnet (e.g., an annularly-shaped magnet). In some embodiments, the one or more rotors 130 are positioned around the spline bearings 134 such that rotation of a rotor 130 causes rotation of the spline bearings 132, which in turn causes rotation of the shaft 104 of the actuator 100.

Turning next to FIG. 3C, the shaft 104 of the actuator 100 is now depicted with stators 126 for rotatably actuating the corresponding rotors 130. Each stator 126 may include an electrically conductive medium, such as set of coils (not shown) for electric current to run through. The magnetic field generated when current running through the coils magnetically actuates the rotors 130, thereby causing rotation of the spline bearings 134 and hence the shaft 104. Thus, the shaft 104 of the actuator 100 can repeatedly rotate in clockwise and counter-clockwise directions by repeatedly switching the current flow to the coils of the stators 126.

FIG. 3D illustrates the shaft 104 of the actuator 100 as secured to the piston assembly 134 via the rotary bearings 118. As shown in this figure, the piston assembly 134 includes a linear scale 124 for indicating the linear position of the piston assembly 134 to a linear encoder 114 (shown in FIG. 1 and FIG. 2). Since the linear actuator 100 can determine both the linear position of the piston assembly 134 (e.g., via the linear scale 124 and linear encoder 114) as well as the rotational of the shaft 104 (e.g., via the rotary scale 122 and the rotary encoder 106), positional data may be used to monitor the operation of the actuator 100. In some embodiments, the linear encoder 114 and/or the rotary encoder 106 are adapted to control operation of the linear actuator 100 based upon one or more designated parameters. These parameters may include, without limitation, linear force, linear speed, linear position, linear acceleration, rotational force, rotational speed, rotational position, and rotational acceleration.

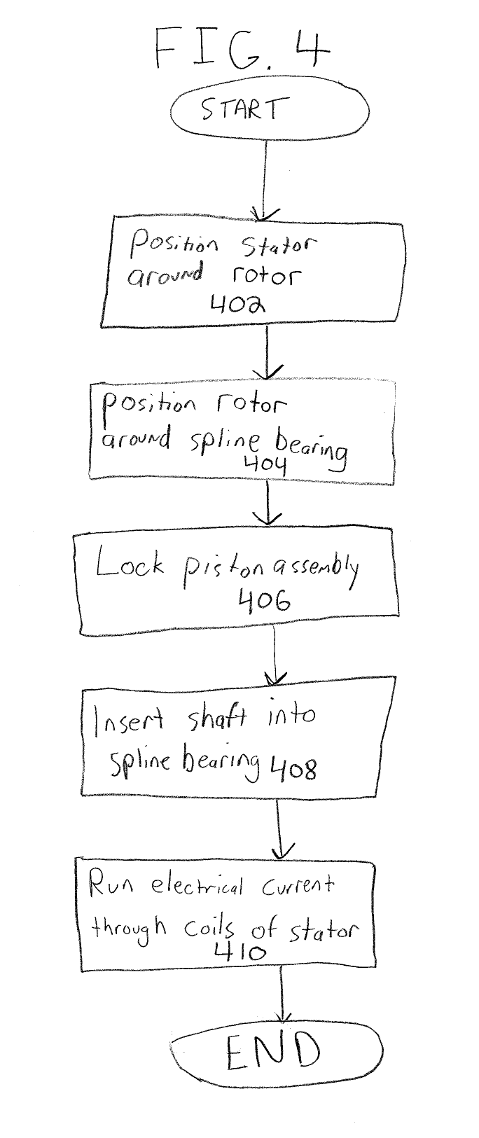

FIG. 4 is a flow diagram of an exemplary method of rotatably engaging a shaft with a rotary motor that remains fixed irrespective of the linear position of the shaft according to one embodiment of the present invention.

At block 402, a stator may be positioned around a rotor (e.g., a rotary bearing). In some embodiments, both the stator and the rotor may be formed into an annular shape, where the stator includes a set of coils and is adapted to remain fixed, and where the rotor is adapted to rotate relative to the stator upon being magnetically actuated by a magnetic field generated when current is running through the set of coils.

At block 404, the rotor is positioned around a spline bearing (e.g., a ball spline) so as to rotatably engage the spline bearing upon actuation from the magnetic field generated by the stator. In some embodiments, the rotor comprises an annular body having a central aperture adapted to fit around the periphery of the spline bearing. Thus, when the rotor is magnetically actuated by the stator (i.e., rotates), the spline bearing rotates in tandem.

At block 406, the piston assembly of the actuator is locked. This may be accomplished, for example, by inserting a locking pin or external spline shaft into an aperture formed directly in the piston assembly or inside a rotational lock that is connected to the piston assembly. In some embodiments, the aperture is adapted to slide over the locking pin or external spline shaft as the piston assembly is repeatedly actuated. Optionally, the rotational lock may include a spline bearing for reducing a level of friction between the rotational lock and the external spline shaft as the piston assembly is actuated.

At block 408, the shaft of the actuator is inserted into the spline bearing. In some embodiments, the spline shaft includes a set of one or more grooves running along its length. A set of protrusions formed on the inside surface of the spline bearing are adapted to interface with the set of one or more grooves of the spline shaft and thereby prevent the shaft from rotating relative to the spline bearing.

At block 410, current is run through the coils of the stator. The magnetic field generated thus causes rotation of the rotor, the spline bearing, and hence, the shaft. Since the shaft of the actuator may be linearly actuated without bearing the mass of the rotary motor, operational performance of the actuator may be substantially improved.

Note that various actuators 100 described herein can be manufactured and assembled quickly and cost-effectively. Further, the actuators 100 may be manufactured to be relatively small, lightweight, and compact. Optionally, use of optical linear and rotary encoder assemblies 114 and 106 can provide monitoring and control over 100% of movement affected by the actuators 100. Additionally, the individual design of the main housing 110, the magnet housing 112, and the piston assembly 134 can provide flexibility and easy reconfigurability so that various actuator configurations can conform to the specifications of a particular project.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

What is claimed is:

1. A linear rotary actuator, comprising:
a piston assembly comprising a rotatable shaft and a lock for engaging a pin adapted to prevent the piston assembly from rotating, wherein the shaft includes a groove for interfacing with a first bearing;
the first bearing adapted to engage the shaft at the groove and therefore prevent the shaft from rotating relative to the first bearing;
a second bearing comprising a magnet and adapted for being positioned around the first bearing; and
a stator comprising a set of coils and adapted for being positioned around the second bearing, wherein the second bearing is adapted to rotatably engage the first bearing when current is flowing through the set of coils.

2. The linear rotary actuator of claim 1, wherein the first bearing comprises a spline bearing.

3. The linear rotary actuator of claim 1, wherein the first bearing is adapted to reduce a level of friction associated with linear movement of the rotatable shaft.

4. The linear rotary actuator of claim 1, wherein the first bearing comprises a set of globules adapted to circulate within the first bearing upon linear movement of the rotatable shaft.

5. The linear rotary actuator of claim 1, wherein the second bearing comprises a rotary bearing.

6. The linear rotary actuator of claim 1 further comprising a rotary scale adapted to indicate to a rotary encoder an amount of rotation of the rotatable shaft.

7. The linear rotary actuator of claim 1 further comprising a linear scale adapted to indicate to a linear encoder an amount of linear movement of the piston assembly.

8. A method for rotatably engaging a first shaft disposed within a piston assembly of a linear actuator with a rotary motor that remains fixed irrespective of the linear position of the first shaft, the method comprising:
positioning a stator comprising a set of coils around a rotary bearing comprising at least one magnet;
positioning the rotary bearing around a first spline bearing adapted to receive the first shaft, wherein the rotary bearing is adapted to rotatably engage the first spline bearing, and wherein the first spline bearing is adapted to prevent rotation of the first shaft relative to the first spline bearing;
inserting a second shaft into a rotational lock formed within the piston assembly;
inserting the first shaft into the first spline bearing; and
running an electrical current through the set of coils.

9. The method of claim 8, wherein at least one of the first shaft and the second shaft comprises a spline shaft.

10. The method of claim 8, wherein the rotational lock comprises a second spline bearing.

11. The method of claim 8 further comprising determining an amount of rotation of the first shaft by reading a rotary scale connected to the linear actuator.

12. The method of claim 8 further comprising determining an amount of linear movement of the piston assembly by reading a linear scale connected to the linear actuator.

13. The method of claim 8 further comprising:
specifying an amount of rotation necessary for a first task to be performed by the linear actuator; and
determining whether the amount of rotation necessary for the first task has been attained by reading a rotary scale connected to the linear actuator.

14. The method of claim 8 further comprising:
specifying an amount of linear movement necessary for a first task to be performed by the linear actuator; and
determining whether the amount of linear movement necessary for the first task has been attained by reading a linear scale connected to the linear actuator.

15. An apparatus for performing a task requiring linear and rotational motion, the apparatus comprising:
a piston assembly comprising a lock adapted to prevent the piston assembly from rotating;
a spline shaft connected to the piston assembly;
a rotary motor comprising a stator and a rotor, wherein the rotor comprises at least one magnet, and wherein the stator comprises a set of coils and is positioned around the rotor; and
a spline bearing positioned inside the rotor and adapted to interface with the spline shaft at a groove formed within the spline shaft.

16. The apparatus of claim 15, wherein the lock comprises an opening adapted to receive a pin, and wherein the lock is adapted to slide upon the pin as the piston assembly is actuated.

17. The apparatus of claim 15, wherein the piston assembly comprises a bobbin having a central axis approximately collinear with the spline shaft.

18. The apparatus of claim 15, wherein the spline shaft is connected to the piston assembly at one or more rotary bearings.

19. The apparatus of claim 15 further comprising a linear encoder for reading a linear scale connected to the apparatus.

20. The apparatus of claim 15 further comprising a rotary encoder for reading a rotary scale connected to the apparatus.
